(19) United States
(12) Patent Application Publication
(10) Pub. No.: US 2015/0358999 A1
(43) Pub. Date: Dec. 10, 2015

(54) Method for Sending Cluster Message, Network-Side Device and Terminal Device

(71) Applicant: ZTE CORPORATION, Shenzhen, Guangdong (CN)

(72) Inventors: Zhuo LIU, Shenzhen (CN); Liangbin LI, Shenzhen (CN); Fei YANG, Shenzhen (CN)

(21) Appl. No.: 14/759,415

(22) PCT Filed: Aug. 28, 2013
(86) PCT No.: PCT/CN2013/082436

§ 371 Date: Jul. 7, 2015

(30) Foreign Application Priority Data
Jan. 9, 2013 (CN) 201310007171.2

(51) Int. Cl. H04W 74/00

(52) U.S. Cl. CPC H04W 74/002; H04W 84/042

(57) ABSTRACT

A method for sending a cluster message comprises: configuring a preamble range for random access of a cluster terminal under a current cell, and a base station notifying each terminal of the configured preamble range for random access of the cluster terminal through a broadcast message; the base station receiving a random access request initiated by the terminal, and if it is determined that the terminal transmits a cluster message through a random access process by a preamble in the random access request, then performing Msg3 authorization on the terminal according to a type of the cluster random access, and notifying the terminal of an authorization result through an Msg2; the terminal receiving the Msg2, forming an Msg3 according to the authorization result in the Msg2 and uplink information to be sent, and sending the Msg3 to a network side.

### TECHNICAL FIELD

The present document relates to the cluster communication field, and in particular, to a scheme of transmitting a cluster message by using a random access process.

### BACKGROUND

The cluster communication system is a system which relies mainly on the simplex and half duplex, and mainly focuses on the voice services. In the cluster communication system, there is only one cluster terminal which has the words right, and the rest of the cluster terminals are in the listening state or the idle state and only need the downlink synchronization, but the listening users still need to report the state information to the base station, so that the base station performs the corresponding scheduling according to the channel quality situation of the cluster terminal; and the listening users still need to send the relevant signaling to the base station when performing the operations such as applying and releasing the words right, etc., so that the base station allocates the resources.

Based on the characteristics of the above-mentioned cluster communication system, if the related art is used, it is required to establish the radio resource control (RRC) connection for each listening user as well, and to transmit the corresponding information on the uplink physical channel, which is obviously not suitable for the cluster system; because the downlink data of the listening users are the same, there is no need to transmit a copy of same data for each listening user and establish a RRC connection for each listening user, and the system capacity will be small.

The random access technology is an important technology of the media access control in the communication system. In the LTE, the random access is the access process of the terminal before the communication, mainly used for the purposes such as the initial access of the terminal, the reconstruction and switching of the radio resource control (RRC) connection, etc.

In the LTE system, aiming at the characteristics of the cluster communication system, the relevant cluster information can be carried through the Msg3 in the random access process based on competition, so that it is able to not establish a RRC connection for each listening user in the cluster system, and the purpose of transmitting the uplink data can be achieved, which effectively improves the system capacity and saves the system resources.

### SUMMARY

The technical problem that the present document requires to solve is to provide a method for sending a cluster message, a network side device and a terminal device, to improve the utilization rate of the system resources.

In order to solve the above-mentioned technical problem, the present document discloses a method for sending a cluster message, comprising:

configuring a preamble range for random access of a cluster terminal under a current cell, and a base station notifying each terminal of the configured preamble range for random access of the cluster terminal through a broadcast message;

the base station receiving a random access request initiated by the terminal, and if determining that the terminal transmits a cluster message through a random access process by a preamble in the random access request, then performing Msg3 authorization on the terminal according to a type of the cluster random access, and notifying the terminal of an authorization result through an Msg2;

the terminal receiving the Msg2, forming an Msg3 according to the authorization result in the Msg2 and uplink information to be sent, and sending the Msg3 to a network side; and

the network side receiving and analyzing the Msg3 message, and acquiring the cluster message reported by the terminal therefrom.

Preferably, in the above-mentioned method, uplink information carried by the Msg3 sent by the cluster terminal comprises state information and signaling of the cluster terminal.

Preferably, in the above-mentioned method, a static or dynamic configuration mode is adopted for configuring the preamble range for the random access of the cluster terminal under the current cell.

Preferably, in the above-mentioned method, when a dynamic mode is adopted for configuring the preamble range for the random access of the cluster terminal, the preamble range for the random access of the cluster terminal is dynamically adjusted through a number of the cluster numbers and a number of normal long term evolution (LTE) terminals accessed under the current cell.

Preferably, in the above-mentioned method, the base station dynamically adjusts the preamble range for the random access of the cluster terminal through a number of the cluster terminals and a number of normal long term evolution (LTE) terminals accessed under the current cell.

The present document further discloses a network side device, comprising a sending module, a judgment module and a cluster terminal random access processing module, wherein,

the sending module is configured to: notify each terminal of a configured preamble range for random access of a cluster terminal under a current cell through a broadcast message;

the judgment module is configured to: receive a random access request initiated by the terminal, and acquire a preamble in the random access request, and send the random access request to the cluster terminal random access processing module when determining that the random access request is the random access of the cluster terminal according to the preamble range used for random access of the cluster terminal configured by the configuration module;

the cluster terminal random access processing module is configured to: receive the random access request sent by the judgment module, perform Msg3 authorization on the terminal which initiates the request according to a type of the random access, and notify the terminal of an authorization result through an Msg2; and analyze the Msg3 message sent by the terminal, and acquire the cluster message reported by the terminal therefrom.

The present document further discloses a terminal device, comprising:

a first module, configured to: acquire a preamble range for random access of a cluster terminal configured by a network side through a broadcast message, and when where is a need for a cluster operation, select a corresponding preamble in the preamble range for the random access of the cluster terminal to send a random access request to a base station; and

a second module, configured to: receive an Msg2 sent by the base station, form an Msg3 according to an authorization result in the Msg2 and uplink information to be sent, and send the Msg3 to the base station.

Preferably, in the above-mentioned terminal device, the first module is configured to: when there is a need for the following cluster operations, initiate a random access request used for the random access of the cluster terminal:

reporting state information, applying for words right, occupying the words right, and releasing the words right.

Preferably, in the above-mentioned terminal device, uplink information carried by the Msg3 sent by the second module comprises state information and signaling of the cluster terminal.

The technical scheme of the present application saves the system resources effectively and improves the system capacity.

### BRIEF DESCRIPTION OF DRAWINGS

FIG. 1 is a flow chart of sending a cluster message in the present embodiment;

FIG. 2 is a division diagram of Preambles in the present embodiment.

### PREFERRED EMBODIMENTS OF THE PRESENT DOCUMENT

The technical scheme of the present document is described in detail with reference to the accompanying drawings hereinafter. It should be illustrated that, in the case of not conflicting, the embodiments in the present application and features in these embodiments can be combined with each other.

### Embodiment 1

The inventor of the present case considers that an Msg3 message in a random access process can be used to carry the corresponding cluster state information and cluster signaling; and in order to enable the base station distinguish the random access of the cluster terminal and the random access process of the normal LTE, the Preamble can be divided so that a section of the Preamble is used for the random access process initiated by the cluster terminal. At this moment, the base station just distinguishes whether the random access initiated by the terminal is used to transmit the cluster message through the Preamble.

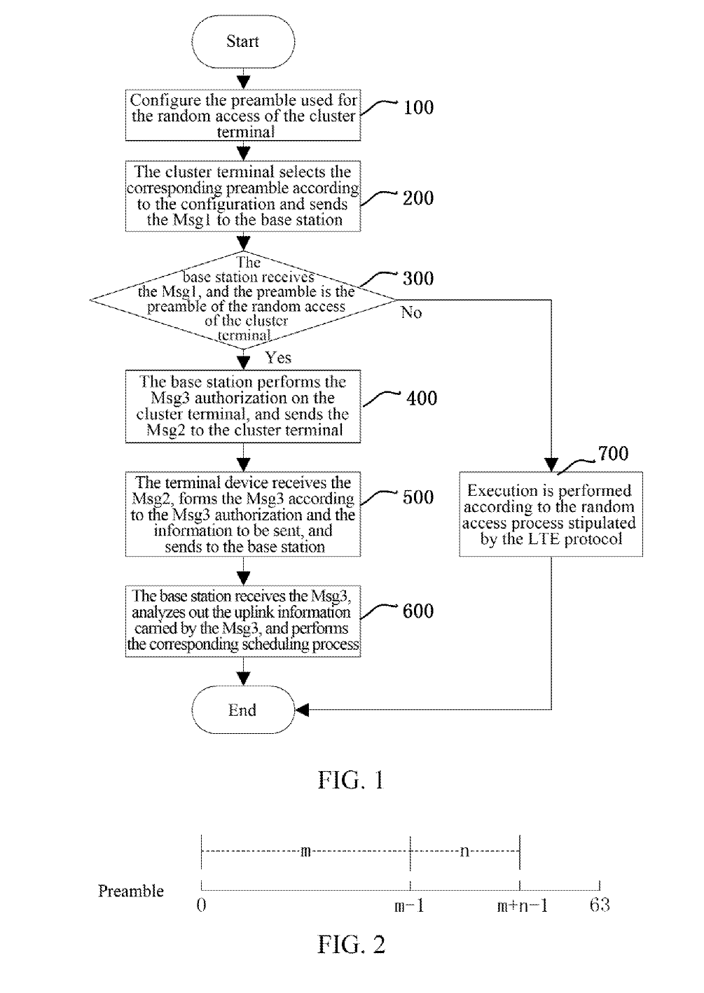

Based on the above ideas, the present embodiment provides a method for sending a cluster message, as shown in FIG. 1, including the following steps from 100 to 700.

In step 100, the network side configures the preamble range of the base station used for the random access of the cluster terminal under the current cell, and notifies it to each cluster terminal through the broadcast message.

When the configuration operation is performed in the present step, it can be synchronized to the foreground and terminal through the background static configuration. The foreground can also dynamically adjust the Preamble range through the number of the cluster terminals and the number of the normal LTE terminals accessed under the current cell. For example, the Preamble range used for the random access of the cluster terminal is configured according to a ratio of the number of the cluster terminals and the number of the normal LTE terminals. The more the number of the type of terminals is, the more the number of the Preamble of the random access configured for it.

Wherein, the Preamble range used for different access processes can be configured referring to the mode as shown in FIG. 2. In particular, the resources used in the random access process of the cluster terminals are distinguished with the resources used in the random access processes of the LTE terminals, to reduce the probability of the random access collision. It is considered that 64 Preambles are divided into three blocks, one block is used for the competition random access of the normal LTE; one block is used for the cluster random access; and one block is used for the non-competition random access of the normal LTE. For example, the number of the Preambles used for the competition random access of the normal LTE is m, and the Preamble index is [0, m−1]; the number of the Preambles used for the cluster access is n, and the Preamble index is offset on the basis of the Preamble of the competition random access of the normal LTE, and the Preamble index is [m−1, m+n−1]; and the rest of the Preambles with the index as [m+n−1˜63] are used for the non-competition access.

In step 200, when the terminal without the words right under the current cell needs to send the information to the base station, the terminal initiates the random access process, selects the corresponding Preamble within the Preamble interval used for the random access process of the cluster terminal and sends the random access request (that is, Msg1) to the base station.

Wherein, the moment that the cluster terminal initiates the random access includes but not limited to the following:

reporting the state information, applying for the words right, occupying the words right, and releasing the words right.

In step 300, the base station receives the random access request initiated by the terminal, and distinguishes that the random access request is the normal random access request or the random access of the cluster terminal (i.e., transmitting the cluster message through the random access process) through the Preamble therein; if it is the random access of the cluster terminal, then step 400 is executed; otherwise, step 700 is executed.

In step 400, the base station performs the Msg3 authorization according to the type of the cluster random access, and sends the authorization result to the terminal device through the Msg2.

In step 500, the terminal device receives the Msg2, forms the Msg3 according to the authorization result and the uplink information to be sent in the Msg2, and sends the Msg3 to the base station.

In step 600, the base station receives the Msg3; if the Msg3 message is successfully analyzed, then the cluster message reported by the terminal is acquired through the corresponding field, and the process is over.

In step 700, it is executed according to the normal random access process.

### Embodiment 2

The network side device provided by the present embodiment at least includes a sending module, a judgment module and a cluster terminal random access processing module.

The sending module is configured to: notify each terminal of a configured preamble range for random access of a cluster terminal under a current cell through a broadcast message.

Wherein, under the configured current cell, the Preamble range used for the random access of the cluster terminal can be configured through the background statically or dynamically, and then the Preamble range is synchronized to the foreground of the base station.

The judgment module is configured to: receive a random access request initiated by the terminal, and acquire a preamble in the random access request, and send the random access request to the cluster terminal random access processing module when determining that the random access request is the random access of the cluster terminal according to the preamble range used for random access of the cluster terminal configured by the configuration module.

The cluster terminal random access processing module is configured to: receive the random access request sent by the judgment module, perform Msg3 authorization on the terminal which initiates the request according to a type of the random access, and notify the terminal of an authorization result through an Msg2; and analyze the Msg3 message sent by the terminal, and acquire the cluster message reported by the terminal therefrom.

It also should be explained that, the preferable scheme proposes that the configuration module can dynamically adjust the preamble range used for the random access of the cluster terminal through a number of the cluster terminals and a number of normal LTE terminals accessed under the current cell.

Specifically, the above-mentioned network side device is the base station.

### Embodiment 3

The present embodiment provides a terminal device, including a first module and a second module.

The first module is configured to: acquire a preamble range for random access of a cluster terminal configured by a network side through a broadcast message, and when where is a need for a cluster operation, select a corresponding preamble in the preamble range for the random access of the cluster terminal to send a random access request to a base station.

Specifically, the first module can initiate a random access request used for the random access of the cluster terminal when there is a need for the following cluster operation:

reporting state information, applying for words right, occupying the words right, and releasing the words right.

Certainly, it not limited to the above-mentioned several operations.

The second module is configured to: receive an Msg2 sent by the base station, form an Msg3 according to an authorization result in the Msg2 and uplink information to be sent, and send the Msg3 to the base station.

Wherein, uplink information carried by the Msg3 sent by the second module includes state information and signaling of the cluster terminal.

It can be seen from the above embodiments, in the technical scheme of the present application, in order to achieve transmitting the uplink information of the user without the words right in the cluster system and as far as possible to save the system resources, the random access of the user without the words right is distinguished from the random access of other users through dividing different Preamble ranges in the process of the random access processing, and it extends the Msg3 in the random access process of the user without the words right to carry the corresponding state information or signaling, etc., so as to achieve the objective that the user without the words right can just complete reporting the uplink information while does not need to establish the RRC connection, which improves the system capacity.

It can be understood by those skilled in the art that all or part of steps in the above-mentioned method can be fulfilled by programs instructing the relevant hardware components, and the programs can be stored in a computer readable storage medium such as a read only memory, a magnetic disk or an optical disk, etc. Alternatively, all or part of the steps in the above-mentioned embodiments can be implemented with one or more integrated circuits. Accordingly, each module/unit in the above-mentioned embodiments can be implemented in the form of hardware, or in the form of software function module. The present document is not limit to any specific form of the combination of the hardware and software.

The above description is only the preferred embodiments of the present document and is not intended to limit the present document. For those skilled in the art, the present document can have various modifications and variations. All of modifications, equivalents and/or variations without departing from the spirit and essence of the present document should be embodied in the scope of the appending claims of the present document.

### INDUSTRIAL APPLICABILITY

The technical scheme of the present application saves the system resources effectively and improves the system capacity.

What is claimed is:

1. A method for sending a cluster message, comprising:
configuring a preamble range for random access of a cluster terminal under a current cell, and a base station notifying each terminal of the configured preamble range for random access of the cluster terminal through a broadcast message;
the base station receiving a random access request initiated by the terminal, and if determining that the terminal transmits a cluster message through a random access process by a preamble in the random access request, then performing Msg3 authorization on the terminal according to a type of the cluster random access, and notifying the terminal of an authorization result through an Msg2;
the terminal receiving the Msg2, forming an Msg3 according to the authorization result in the Msg2 and uplink information to be sent, and sending the Msg3 to a network side; and
the network side receiving and analyzing the Msg3 message, and acquiring the cluster message reported by the terminal therefrom.

2. The method according to claim 1, wherein, uplink information carried by the Msg3 sent by the cluster terminal comprises state information and signaling of the cluster terminal.

3. The method according to claim 1, wherein, a static or dynamic configuration mode is adopted for configuring the preamble range for the random access of the cluster terminal under the current cell.

4. The method according to claim 3, wherein, when a dynamic mode is adopted for configuring the preamble range for the random access of the cluster terminal, the preamble range for the random access of the cluster terminal is dynamically adjusted through a number of the cluster numbers and a number of normal long term evolution (LTE) terminals accessed under the current cell.

5. The method according to claim 1, wherein, the base station dynamically adjusts the preamble range for the random access of the cluster terminal through a number of the cluster terminals and a number of normal long term evolution (LTE) terminals accessed under the current cell.

6. A network side device, comprising a sending module, a judgment module and a cluster terminal random access processing module, wherein,
the sending module is configured to: notify each terminal of a configured preamble range for random access of a cluster terminal under a current cell through a broadcast message;
the judgment module is configured to: receive a random access request initiated by the terminal, and acquire a preamble in the random access request, and send the random access request to the cluster terminal random access processing module when determining that the random access request is the random access of the cluster terminal according to the preamble range used for random access of the cluster terminal configured by the configuration module;
the cluster terminal random access processing module is configured to: receive the random access request sent by the judgment module, perform Msg3 authorization on the terminal which initiates the request according to a type of the random access, and notify the terminal of an authorization result through an Msg2; and analyze the Msg3 message sent by the terminal, and acquire a cluster message reported by the terminal therefrom.

7. A terminal device, comprising:
a first module, configured to: acquire a preamble range for random access of a cluster terminal configured by a network side through a broadcast message, and when where is a need for a cluster operation, select a corresponding preamble in the preamble range for the random access of the cluster terminal to send a random access request to a base station; and
a second module, configured to: receive an Msg2 sent by the base station, form an Msg3 according to an authorization result in the Msg2 and uplink information to be sent, and send the Msg3 to the base station.

8. The terminal device according to claim 7, wherein, the first module is configured to: when there is a need for the following cluster operations, initiate a random access request used for the random access of the cluster terminal:
reporting state information, applying for words right, occupying the words right, and releasing the words right.

9. The terminal device according to claim 7, wherein, uplink information carried by the Msg3 sent by the second module comprises state information and signaling of the cluster terminal.

10. The method according to claim 2, wherein, the base station dynamically adjusts the preamble range for the random access of the cluster terminal through a number of the cluster terminals and a number of normal long term evolution (LTE) terminals accessed under the current cell.

11. The method according to claim 3, wherein, the base station dynamically adjusts the preamble range for the random access of the cluster terminal through a number of the cluster terminals and a number of normal long term evolution (LTE) terminals accessed under the current cell.

12. The method according to claim 4, wherein, the base station dynamically adjusts the preamble range for the random access of the cluster terminal through a number of the cluster terminals and a number of normal long term evolution (LTE) terminals accessed under the current cell.

13. The terminal device according to claim 8, wherein, uplink information carried by the Msg3 sent by the second module comprises state information and signaling of the cluster terminal.
